(19) United States
(12) Patent Application Publication
(10) Pub. No.: US 2005/0019089 A1
(43) Pub. Date: Jan. 27, 2005

(54) Disposable single-use applicator with seal opening cap

(76) Inventors: Gary Ashe, Sanborn, NY (US); Edward M. Purizhansky, Williamsville, NY (US)

Correspondence Address: Walter W. Duft, Suite 10, 10255 Main Street, Clarence, NY, 14031, US

(21) Appl. No.: 10/651,295

(22) Filed: Aug. 28, 2003

Related U.S. Application Data
(60) Provisional application No. 60/406,599, filed on Aug. 28, 2002.

(51) Int. Cl. B43K 5/00; B43K 8/22

(52) U.S. Cl. 401/202; 401/196

(57) ABSTRACT

An applicator and seal opening cap assembly includes a container that is adapted to carry a fluid therein and formed with a neck. A porous applicator tip is secured to the container. An orifice provides a fluid pathway from a fluid holding portion of the container to the applicator tip. A seal is disposed to cover the orifice. A closure cap is mounted on the neck. A seal opening system is provided for breaking the seal upon movement of the cap toward the fluid holding portion of the container.

### CROSS REFERENCE TO RELATED APPLICATIONS

This application claims the benefit under 35 U.S.C. 119(e) of United States Provisional Patent Application Ser. No. 60/406,599, filed on Aug. 28, 2002, entitled “Disposable Single-Use Applicator With Removable Seal Opening Cap.”

### BACKGROUND OF THE INVENTION

1. Field of the Invention

The present invention relates to applicators for applying fluids to a surface, and particularly to disposable applicators for applying fluids on a single-use basis.

2. Description of the Prior Art

By way of background, various applicators for dispensing fluid material have been proposed in the prior art. According to one design approach, an applicator includes a container that is filled with a fluid to be dispensed. A seal closes an opening at one end of the container. A cap is threadably or slidably mounted at the same end of the container so as to be adapted for relative axial movement therewith toward and away from the body of the container. A porous applicator tip is mounted to and extendable from one end of the cap for applying the fluid in the container. The cap also carries a seal opening member that is adapted to puncture or otherwise open the seal when the cap is advanced axially toward the container body. This allows the fluid to leave the container and impregnate the applicator tip.

It is to improving applicators of the foregoing type that the present invention is directed. In particular, a low cost disposable applicator that is optimized for single use only is needed.

### SUMMARY OF THE INVENTION

The foregoing problems are solved and an advance in the art is provided by an applicator and seal opening cap assembly. The assembly includes a container that is adapted to carry fluid therein and formed with a neck. A porous applicator tip is secured to the container. An orifice provides a fluid pathway from a fluid holding portion of the container to the applicator tip. A seal is disposed to cover the orifice. A closure cap is disposed on the neck. A seal opening system is provided for breaking the seal upon movement of the cap toward the fluid holding portion of the container.

### BRIEF DESCRIPTION OF THE DRAWING

The foregoing and other features and advantages of the invention will be apparent from the following more particular description of preferred embodiments of the invention, as illustrated in the accompanying Drawing in which:

FIG. 1 is a front elevational view showing an applicator and seal opening cap assembly in accordance with a first embodiment of the invention which the applicator is charged with a fluid and fully sealed for subsequent use;

FIG. 2 is a cross-sectional view taken along line 2-2 in FIG. 1;

FIG. 3 is a partial enlargement of the cross-sectional view of FIG. 2 showing details of a seal opening system for use with the assembly of FIG. 1;

FIG. 4 is a partial enlarged cross-sectional view of the seal opening system of FIG. 3 following seal rupture;

FIG. 5 is a partial enlarged cross-sectional view of the seal opening system of FIG. 3 following cap removal;

FIG. 6 is a partial enlarged cross-sectional view of an alternative seal opening system for use with the assembly of FIG. 1;

FIG. 7 is a partial enlarged cross-sectional view of another alternative seal opening system for use with the assembly of FIG. 1;

FIG. 8 is a side elevational view showing an applicator and seal opening cap assembly in accordance with a second embodiment of the invention in which the applicator is not yet charged with a fluid and has an opening adapted to receive such fluid and a closure member to cover the opening;

FIG. 9A is a diagrammatic view showing the assembly of FIG. 8 and a system for charging the applicator with a dispensable fluid; and

FIG. 9B is a side elevational view of the assembly of FIG. 8 after the applicator is charged with a dispensable fluid and the opening in the applicator is ready to be closed with the closure member.

### DETAILED DESCRIPTION OF PREFERRED EMBODIMENTS

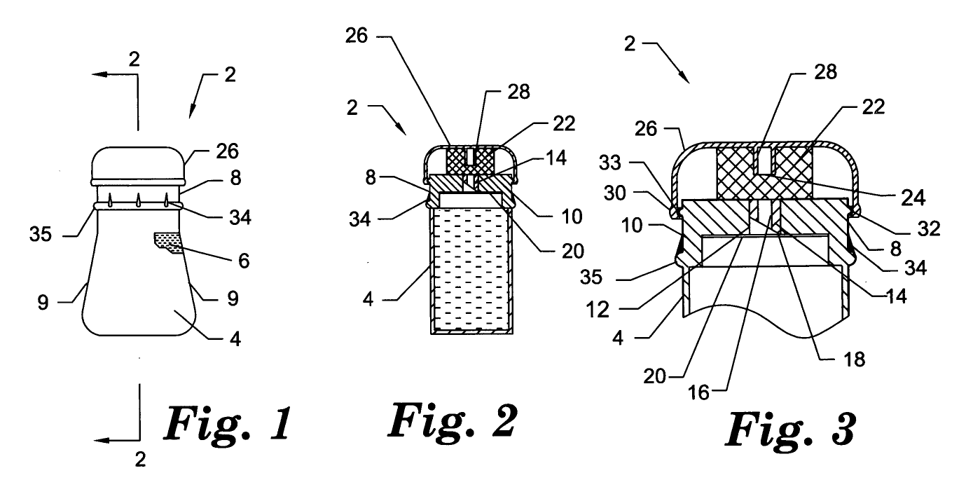

Turning now to the figures, wherein like reference numerals represent like elements in all of the several views, FIGS. 1-3 illustrate a disposable single-use applicator 2 constructed in accordance with a first embodiment of the invention. The applicator 2 comprises a container 4 that contains a fluid 6 to be dispensed. The top of the container 4 is formed with a neck portion 8 that is generally cylindrical in FIGS. 1-3 but need not be limited to any particular shape or size so long as it is capable of supporting a closure cap, as described in more detail below. Downwardly from the neck portion 8, the container 4 flares outwardly along a pair of tapered side walls 9 to form a fluid holding body portion of the container. As can be seen by comparing FIGS. 1 and 2, the container is only flared in one dimension. However, this configuration is exemplary only and it should be understood that the fluid holding body portion of the container can be constructed according to any desired shape and size. The container 4, moreover, can have any desired rigidity depending on whether it is to be squeezable (non-rigid) or non-squeezable (rigid), and can be made from any suitable material that has the desired rigidity and is impervious to the fluid 6. Exemplary materials include molded plastic, glass, metal, etc. When the container 4 has a configuration such as that shown in FIGS. 1-3, it will normally be designed to have medium to high rigidity. Medium rigidity would be provided by molding the container 4 from a material such as moderately flexible plastic (so that it is somewhat squeezable). High rigidity would be provided by forming the container 4 from hard plastic, glass or metal (so that it is non-squeezable). Although not shown, if a very low rigidity container is desired, an alternative container design could be used, such as a flexible pouch made from soft plastic (e.g., like a toothpaste tube) or the like. Many other alternative constructions would also be possible.

The fluid 6 can be for any purpose including medical applications (e.g., wound treatment, etc.), business applications (e.g., typographic correction, etc.), or industrial applications (e.g., lubrication, etc.). Perhaps the only limitation on the fluid 6 is that it be compatible with the materials used to construct the applicator 2, and that its viscosity not be so high that it cannot be dispensed from the applicator under normal use conditions.

A wall 10 or other structure of suitable configuration extends across the opening formed by the neck portion 8 and provides an upper barrier to the fluid 6 within the container 4. A central fluid delivery orifice 12 in the wall 10 provides a fluid pathway out of the fluid holding portion of the container 4. The orifice 12 slidably receives a seal opening member 14 made from plastic or the like. The seal opening member 14 is generally tubular in shape so as to define a central fluid passage 16. The lower end of the seal opening member 14 is tapered to define a relatively sharp point 18. The point 18 is adapted to pierce a frangible seal 20 that covers the bottom of the orifice 12. The seal 20 can be made from aluminum foil or other thin breakable material that is impervious to the fluid 6. This material can be secured to the bottom surface of the wall 10 so as to cover the orifice 12. Alternatively, the seal 20 could be formed integrally with the wall 10, as by a molding process wherein the orifice 12 is formed so that it does not extend completely through the wall, leaving behind a thin membrane that provides the seal 20.

A generally cylindrical applicator tip 22 can be conveniently secured to the container 4 by attaching it to the top of the wall 10 using a suitable lamination or other bonding process. Other configurations for securing the applicator tip 22 to the container 4, which might include the use of additional mounting components (not shown), could also be employed. The applicator tip 22 receives the fluid 6 via the fluid pathway provided by the orifice 12. The applicator tip 22 is porous to the fluid 6 and can be formed as a foam member using a suitable polymeric (e.g., urethane) open cell foam. As shown in FIG. 3, the applicator tip 22 has a central well 24 formed therein in alignment with the orifice 12. The well 24 extends downwardly from the top of the applicator tip 22 for a distance sufficient to receive a closure cap pin (described below). Alternatively, the well 24 could extend completely through the applicator tip 22 to form a bore (see FIG. 7 and related discussion below).

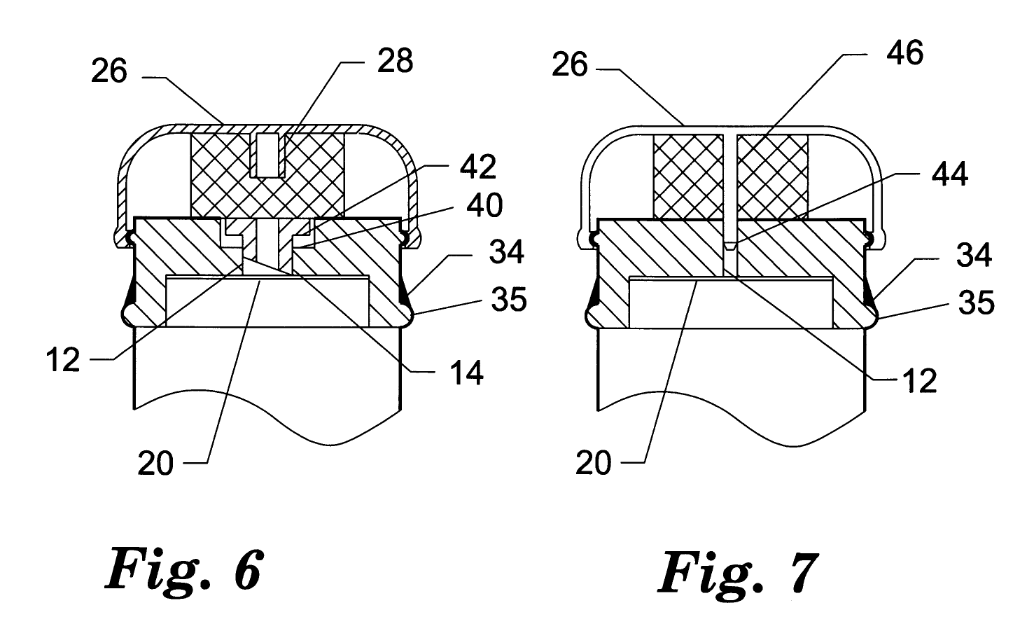

A closure cap 26 made from plastic, metal or other suitable material is adapted to slidably mount onto the container neck portion 8 so as to cover the applicator tip 22. The underside of the cap 26 has a downwardly extending pin 28 that is received in the applicator tip well 24 when the cap is installed on the container. The pin 28 is tubular (or a solid cylinder) and sized with an outside diameter that is larger than the inside diameter of the seal opening member 14. The cap 26 has a lower lip 30 that is held by a rim 32 on the container neck portion 8 prior to use of the applicator 2. To that end, the lower lip 30 is formed with a circumferential recess 33 that engages the circumferential face of the rim 32, as best shown in FIG. 3 (see also FIG. 5). This interconnection prevents inadvertent axial movement of the cap 26 either toward or away from the container's fluid holding portion prior to use.

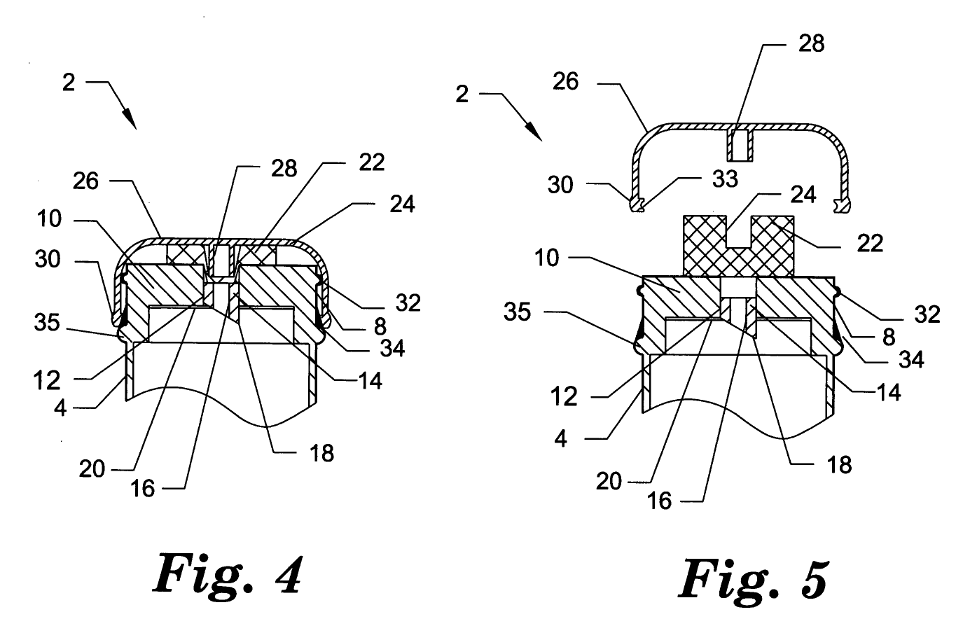

The cap 26 and its pin 28 provides a seal opening system in conjunction with the seal opening member 14 that can be manipulated to break the seal 20 when it is desired to use the applicator 2. With reference now to FIGS. 4 and 5, this process is initiated by a user of the applicator 2 pushing the cap 26 downwardly to break the interconnection between the cap lip 30 and the container rim 32. Continued downward movement of the cap 26 causes the cap pin 28 to squeeze the applicator tip 22 until the cap pin and an underlying compressed portion of the applicator tip actuates the seal opening member 14. Further advancement of the cap 26 causes the point 18 of the seal opening member 14 to pierce the seal 20. Around the same time, the sides of the cap 26 will be broken so that the cap can be easily removed from the container 4. This is accomplished by way of a cap-breaking structure that includes a plurality of pointed ribs 34 (best shown in FIG. 1) extending upwardly from a protruding ring structure 35 formed around the circumference of the container neck portion 8. More particularly, as the cap lower lip 30 meets the ribs 34, the cap will start cracking or splitting upwardly from the lip at the point of contact with each rib. Other cap-breaking configurations could also be used. The foregoing opening procedure will allow the fluid 6 in the container 4 to impregnate the applicator tip 22 when the container is squeezed and/or inverted, such that the fluid can be applied to a desired surface.

Turning now to FIG. 6, an alternative construction of the applicator 2 is shown in which a slightly modified seal opening system is provided. More particularly, the orifice 12 in the wall 10 is stepped to define a ledge 40. The seal opening member 14 is also stepped to provide a flange 42. During downward motion of the cap 26, the flange 42 will engage the ledge 40, thereby preventing further movement of the cap. Moreover, there is no possibility of the seal opening member 14 passing into the fluid holding portion of the container 4, as might be possible with the embodiment of FIGS. 1-3.

Turning now to FIG. 7, another alternative construction of the applicator 2 is shown with another modified seal opening system. In this embodiment, the seal opening member 14 is eliminated and the cap 26 has a modified pin 44 that is longer than the pin 28. The applicator tip 22 is also formed with a central bore 46 instead of the well 24. The pin 42 is adapted to pass through the bore 46 upon downward movement of the cap 26 and to pierce the seal 20. Note that the seal 20 in the construction of FIG. 7 can be located anywhere along the length of the orifice 12 insofar as the seal opening member 14 is not used. For example, the seal 20 could be disposed on top of the wall 10, midway along the length of the orifice 12, etc.

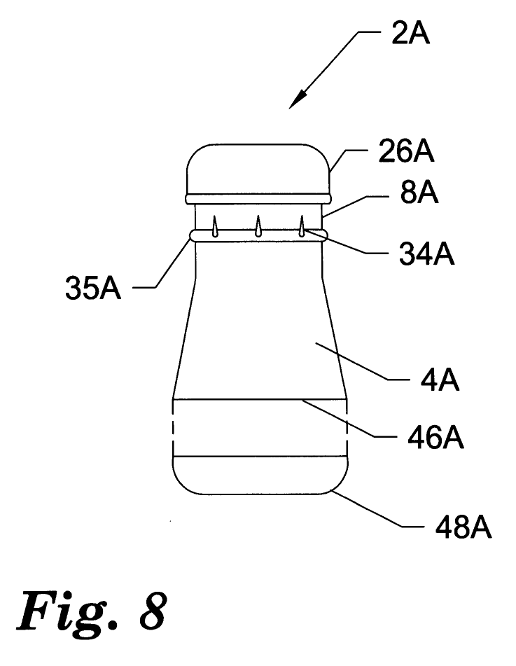

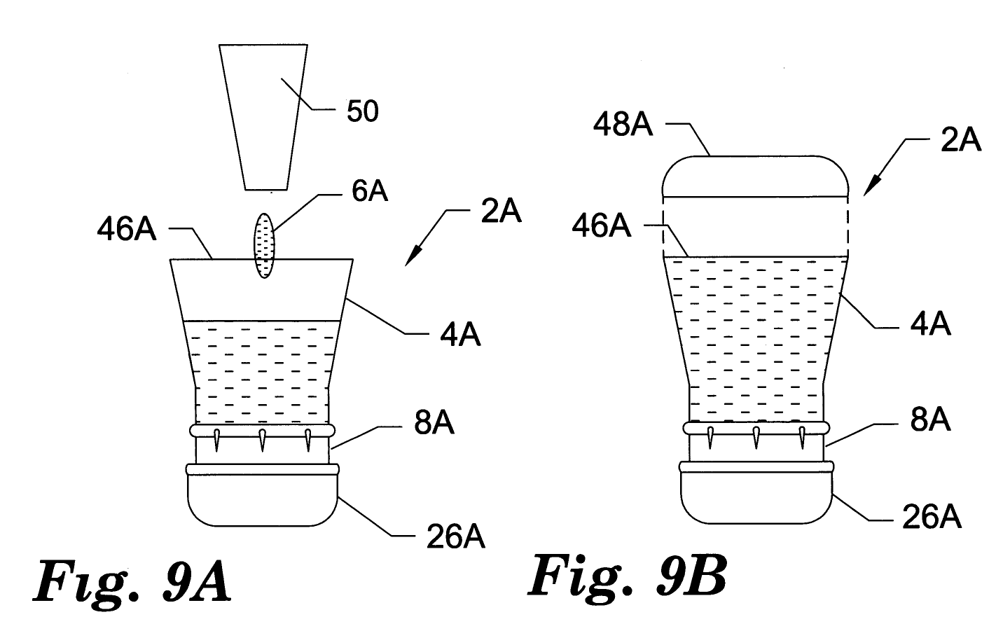

Turning now to FIG. 8, another embodiment of the invention is illustrated in which a disposable single-use applicator 2A is identical in all respects to the applicator 2 described above (as shown by the use of corresponding reference numerals) except that its container 4A is empty and not yet charged with a fluid. Moreover, the container 4A has its bottom removed to form an opening 46A that is adapted to receive a fluid 6A (see FIG. 9A) to be introduced within the container in a future fluid introduction process. In FIG. 8, the opening 46A is shown to span the entire cross-sectional area of the container 4A adjacent the bottom thereof. It will be appreciated, however, that the opening 46A could be of any suitable size and situated at any suitable portion of the container 4A. For example, it may be possible to form the opening as a small hole (not shown) that receives a cannula through which the fluid 6A is injected into the container 4A.

A bottom closure member 48A of the container 4A can be provided with the container for use in the future fluid introduction process. According to this process, and as shown in FIG. 9A, the container 4A is situated below a fluid dispenser 50 and the fluid 6A is dispensed into the container via the opening 46A. As shown in FIG. 9B, when the container 4A is full, the closure member 48A is placed over the opening 46A and hermetically sealed thereto by an appropriate bonding process, such as ultrasonic welding or the like. Note that in cases where the opening 46A is substantially smaller than that shown in FIGS. 8 and 9B, it may be possible to hermetically seal the opening without a closure member, as by applying molten plastic, a sealing agent, etc.

Accordingly an applicator with a removable seal opening cap has been disclosed. While various embodiments of the invention have been shown and described, it should be apparent that many variations and alternative embodiments could be implemented in accordance with the invention. It is understood, therefore, that the invention is not to be in any way limited except in accordance with the spirit of the appended claims and their equivalents.

1. An applicator and seal opening cap assembly, comprising:
a container;
fluid in said container;
a neck on said container;
a porous applicator tip secured to said container;
an orifice providing a fluid pathway from a fluid holding portion of said container to said applicator tip;
a seal disposed to seal said orifice;
a closure cap disposed on said neck; and
a seal opening system for breaking said seal upon movement of said cap toward said fluid holding portion of said container.

2. An applicator and seal opening cap assembly in accordance with claim 1 wherein said seal opening system includes a pin extending downwardly from said cap to actuate seal rupture.

3. An applicator and seal opening cap assembly in accordance with claim 2 wherein said pin effects seal rupture in concert with a seal opening member disposed in said orifice.

4. An applicator and seal opening cap assembly in accordance with claim 3 wherein said seal opening member and said orifice are formed with means for limiting movement of said seal opening member into said container.

5. An applicator and seal opening cap assembly in accordance with claim 2 wherein said pin directly contacts said seal.

6. An applicator and seal opening cap assembly in accordance with claim 1 wherein said cap and said neck include means for preventing inadvertent axial movement of said cap prior to use of said applicator.

7. An applicator and seal opening cap assembly in accordance with claim 1 wherein neck comprises a cap breaking structure.

8. An applicator and seal opening cap assembly in accordance with claim 1 wherein said seal comprises a frangible material arranged to close said orifice.

9. An applicator and seal opening cap assembly in accordance with claim 1 wherein said applicator tip comprises a urethane foam material.

10. An applicator and seal opening cap assembly in accordance with claim 1 and wherein said container comprises a flexible material.

11. An applicator and seal opening cap assembly, comprising:
a container adapted to be filled with a fluid;
an opening in said container to receive a fluid;
a neck on said container;
a porous applicator tip secured to said container;
an orifice providing a fluid pathway from a fluid holding portion of said container to said applicator tip;
a seal disposed to seal said orifice;
a closure cap disposed on said neck; and
a seal opening system for breaking said seal upon movement of said cap toward said fluid holding portion of said container.

12. An applicator and seal opening cap assembly in accordance with claim 11 wherein said seal opening system includes a pin extending downwardly from said cap to actuate seal rupture.

13. An applicator and seal opening cap assembly in accordance with claim 12 wherein said pin effects seal rupture in concert with a seal opening member disposed in said orifice.

14. An applicator and seal opening cap assembly in accordance with claim 13 wherein said seal opening member and said orifice are formed with means for limiting movement of said seal opening member into said container.

15. An applicator and seal opening cap assembly in accordance with claim 12 wherein said pin directly contacts said seal.

16. An applicator and seal opening cap assembly in accordance with claim 11 wherein said cap and said neck include means for preventing inadvertent axial movement of said cap prior to use of said applicator.

17. An applicator and seal opening cap assembly in accordance with claim 11 wherein neck comprises a cap breaking structure.

18. An applicator and seal opening cap assembly in accordance with claim 11 wherein said seal comprises a frangible material arranged to close said orifice.

19. An applicator and seal opening cap assembly in accordance with claim 11 wherein said applicator tip comprises a urethane foam material.

20. An applicator and seal opening cap assembly in accordance with claim 11 and wherein said container comprises a flexible material.

21. An applicator and seal opening cap assembly in accordance with claim 11 wherein said container opening is situated at a bottom section of said fluid holding portion of said container and substantially spans a cross-sectional area of said bottom section.

22. An applicator and seal opening cap assembly in accordance with claim 11 further including a closure member adapted to mount over said container opening when it is desired to seal said container after introducing a fluid therein.

23. A method for producing an applicator and seal opening cap assembly charged with a dispensable fluid comprising:
selecting an uncharged applicator and seal opening cap assembly, comprising:
a container adapted to be filled with a fluid;
an opening in said container to receive a fluid;
a neck on said container;
a porous applicator tip secured to said container;
an orifice providing a fluid pathway from a fluid holding portion of said container to said applicator tip;
a seal disposed to seal said orifice;
a closure cap disposed on said neck; and
a seal opening system for breaking said seal upon movement of said cap toward said fluid holding portion of said container;
charging said applicator and seal opening cap assembly with a dispensable fluid by introducing said fluid into said container via said container opening; and
sealing said opening.
